(19) United States
(12) Patent Application Publication
(10) Pub. No.: US 2018/0370562 A1
(43) Pub. Date: Dec. 27, 2018

(54) METHOD FOR ACTIVE STEERING SUPPORT IN A STUCK VEHICLE AND CONTROL UNIT

(71) Applicant: Continental Teves AG & Co. oHG, Frankfurt (DE)

(72) Inventor: Frank HALLER, Bad Homburg (DE)

(73) Assignee: Continental Teves AG& Co. oHG, Frankfurt (DE)

(21) Appl. No.: 15/780,036

(22) PCT Filed: Dec. 2, 2016
(86) PCT No.: PCT/EP2016/079672

§ 371 Date: May 30, 2018

(30) Foreign Application Priority Data
Dec. 10, 2015 (DE) 10 2015 224 760.0

(51) Int. Cl. B62D 5/04; B62D 6/00; B62D 9/00; B62D 15/02

(52) U.S. Cl. CPC B62D 5/0463; B62D 6/008; B60W 10/20; B62D 15/0205; B62D 15/025; B62D 9/00

(57) ABSTRACT

A method for controlling an electrically actuatable steering actuator for a motor vehicle, wherein a check is carried out in order to determine whether a vehicle is stuck and a special control mode of the steering actuator is activated if a predefined condition is present, wherein the steering actuator is designed to set a steering angle in a manner independent of the driver and the steering actuator sets a steering angle profile in the special control mode.

### CROSS REFERENCE TO RELATED APPLICATIONS

This application is the U.S. National Phase application of PCT International Application No. PCT/EP2016/079672, filed Dec. 2, 2016, which claims priority to German Patent Application No. 10 2015 224 760.0, filed Dec. 10, 2015, the contents of such applications being incorporated by reference herein.

### FIELD OF THE INVENTION

The invention relates to a method for controlling an electrically actuatable steering actuator for a motor vehicle, wherein a check is carried out in order to determine whether a vehicle is stuck and a special control mode is activated if a predefined condition is present.

### BACKGROUND OF THE INVENTION

When driving in the country with a motor vehicle, situations may occur in which the vehicle gets stuck, for example in the case of very uneven terrain or soft ground with poor grip of the wheels, for example sand. Measures are usually taken by the driver in such a situation, for example rocking the vehicle free or moving the steering wheel so that the front wheels have better grip on the ground again. This is often inconvenient for the driver.

DE 10 2008 036 048 A1, incorporated by reference herein, discloses a method in which stuck situations of a motor vehicle or possible imminent stuck situations are detected and an operating mode (rocking-free mode) is activated in which a periodically fluctuating drive torque is automatically provided at the drive wheels of the vehicle, thus causing so-called rocking-free of the vehicle in the longitudinal direction. An alignment of the vehicle wheels along the longitudinal axis by means of a supportive steering actuator system before the rocking-free mode is activated is described.

DE 10 2013 218 664 A1, incorporated by reference herein, also describes a method in which a rocking-free situation is detected and a rocking-free mode is activated, wherein the rocking-free mode is started, blocked, terminated or influenced by the driver.

Such methods have the disadvantage that they do not effectively result in the vehicle being freed from the stuck state in all situations. In certain situations, such a maneuver can even worsen the state. An additional intervention by the driver on the steering wheel is often needed to free the vehicle, particularly in situations with heterogeneous or very uneven ground, for example in the country.

Methods for superimposing an additional steering angle on the steering angle predefined by the driver by means of an actuator according to the specification of a control system (superposition steering) are known per se. Use is usually made of electrical actuators which act on a superposition transmission and set the additional steering angle independently of the driver.

### SUMMARY OF THE INVENTION

An aspect of the present invention is an improved method for assisting the driver in the situation of a stuck vehicle.

An aspect of the invention is based on the consideration that a suitable steering angle profile can cause a stuck vehicle to be freed again. In this case, the steering angle profile is a profile of the steering angle as a function of the time. Such a suitable steering angle profile is therefore set according to an aspect of the invention in a special control mode by a steering actuator which is designed to set a steering angle in a manner independent of the driver.

In one preferred embodiment, the special control mode is activated when a standstill is determined and the standstill lasts longer than a predefined time limit value.

A standstill is advantageously determined whenever an evaluation of the measured wheel speeds of non-driven wheels reveals that these wheels are not turning. This is preferably determined if the measured wheel speeds are below a predefined threshold value. A standstill is advantageously detected only when all non-driven wheels are not turning.

If there are no non-driven wheels of the vehicle (all-wheel vehicle), alternative methods for detecting a standstill are preferably used.

An alternative method for detecting a standstill evaluates data from environmental capture of the vehicle in order to detect a standstill. For example, a standstill can be detected if the environment does not change over a predefined period or if detected objects do not change their position relative to the vehicle over a predefined period.

Further methods for detecting a standstill use, for example, data from a longitudinal acceleration sensor and/or data from a position determination system (for example GPS) and/or evaluate driver actions, for example steering wheel movements.

In one preferred embodiment, the special control mode is activated when a standstill is determined and a determined drive torque is above a predefined limit value. A stuck state is particularly preferably determined if a standstill is determined over a predefined period and a determined drive torque is above a predefined torque limit value during the same period. Such a state of the vehicle reveals a stuck situation with a high degree of reliability.

In one particularly preferred embodiment, the special control mode is activated when all of the following conditions have been met:
a standstill has been determined,
a determined drive torque is above a predefined limit value,
it has been determined that all driven wheels of the vehicle are turning.

The special control mode is preferably activated when said conditions have been met during a predefined period.

In another preferred embodiment, the special control mode is activated by means of an input by the driver. The input by the driver is particularly preferably carried out via an interface, for example a pushbutton.

In one preferred embodiment of an aspect of the invention, the driver receives a message indicating that the special control mode is activated. This message is particularly preferably effected haptically by virtue of not only the steered wheels but also the steering wheel being moved by the steering actuator which sets the steering angle.

Alternatively, a message indicating that the special control mode is activated is given to the driver by means of a visual and/or acoustic signal.

The steering angle profile preferably corresponds to steering back and forth around a reference value. In this case, steering back and forth is understood as meaning a steering angle profile in which a change in the angle in one direction is first of all set and then a change in the other direction is set.

The steering angle profile is particularly preferably controlled in such a manner that the steered wheels are deflected at least once to one side relative to the neutral position (straight wheels) and are then deflected to the other side relative to the neutral position.

In one preferred embodiment, the steering angle profile corresponds to a periodic profile with a predefined period and amplitude. The steering angle profile is advantageously described by a periodic function. Continuously differentiable functions prove to be particularly advantageous since they result in steering movements which are perceived to be uniform by the driver. For example, a sine function can be advantageously used.

A maximum steering angle and a minimum steering angle are preferably predefined for the steering angle profile. A maximum absolute value of the steering lock relative to a reference value is particularly preferably predefined. The reference value corresponds to the neutral position in a very particularly preferred manner.

In the case of a steering angle profile described by a periodic profile with a predefined period and amplitude, the amplitude is selected in such a manner that the maxima and minima of the profile correspond to the minimum and maximum predefined steering angles.

The minimum and maximum steering angles are particularly preferably determined according to an identified ground condition. For example, a smaller maximum (and larger minimum) steering angle is predefined if the vehicle is on sand in order to avoid the vehicle entrenching itself further by the movement of the wheels. A larger maximum (and smaller minimum) steering angle is predefined if the vehicle is on rocky ground, for example. The ground condition can be determined by means of various methods, for example an evaluation of the environmental detection.

In one particularly preferred embodiment, the predefined minimum steering angle and the predefined maximum steering angle are temporally variable and are adapted while the special control mode is active. For example, a steering angle profile with a relatively small maximum steering angle and a relatively large minimum steering angle can first of all be selected and, if this does not result in the stuck state being terminated over a predefined period, a profile with a larger maximum steering angle and a smaller minimum steering angle can then be set. In one preferred embodiment, the maximum steering angle and the minimum steering angle are each calculated on the basis of the time by means of a predefined mathematical function.

According to one preferred embodiment of an aspect of the invention, the special control mode is terminated when a movement of the vehicle in the longitudinal direction is determined. A movement of the vehicle in the longitudinal direction is advantageously determined in this case by means of the same method(s) used to determine a standstill of the vehicle.

According to another preferred embodiment, the special control mode is terminated by means of an input by the driver, wherein such an input can be made via an interface (pushbutton), or by setting a brake pressure which is greater than a brake pressure limit value, or via a movement of the steering wheel, or by holding the steering wheel counter to the setting by the steering actuator during a predefined period.

The driver can advantageously terminate the special control mode at any time. In this case, provision is made for the special control mode to be terminated if the driver intervenes counter to the driver-independent control. This is the case, for example, if the driver holds the steering wheel for a predefined time such that automatic control cannot be carried out or if the driver actively steers counter to the control. A braking intervention by the driver (for example according to a pressure in the main cylinder above a predefined pressure limit value or depressing a brake pedal over a predefined pedal travel) is preferably likewise a termination condition.

A drive torque is preferably predefined by a control unit while the special control mode is active, which drive torque is applied to at least one driven axle. A drive torque is needed to propel the vehicle as soon as the wheels gain traction again. The drive torque is particularly preferably constant over the period for which the special control mode is activated.

Predefining a drive torque by means of a control unit during the special control mode has the advantage that a drive of the wheels is available at any time should they gain traction again. It is difficult and inconvenient for the driver to himself control a uniform torque via a gas pedal.

In one preferred embodiment, the drive torque is continuously increased to a predefined value at the start of the special control mode and/or is continuously reduced to zero at the end of the special control mode.

The drive torque is particularly preferably predefined by an assistance system, in particular an automatic cruise control system. If such an assistance system is active at the start of the special control mode, it is advantageous to use the torque predefined by the assistance system.

### BRIEF DESCRIPTION OF THE DRAWING

An exemplary embodiment of an aspect of the invention will be discussed in more detail on the basis of two drawings. In the drawings, in a highly schematic illustration:

FIG. 1 shows an apparatus for carrying out a method according to an aspect of the invention; and

FIGS. 2A-2F show an exemplary profile of a plurality of variables while carrying out an exemplary method.

### DETAILED DESCRIPTION OF THE PREFERRED EMBODIMENTS

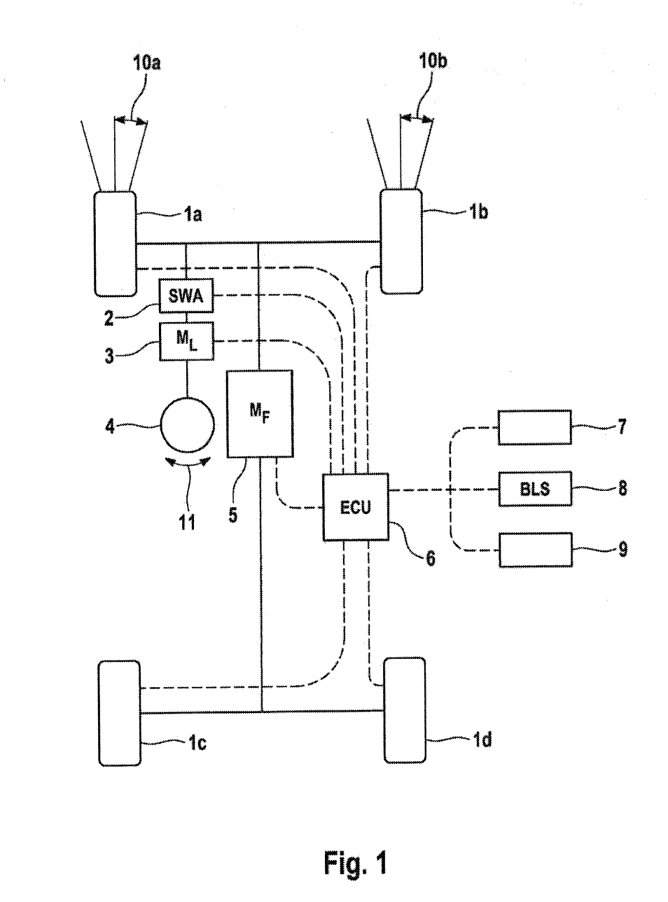

FIG. 1 shows an apparatus for carrying out a method according to an aspect of the invention. The apparatus is contained in a motor vehicle. In this case, 1a, 1b, 1c, 1d denote the wheels of the motor vehicle. The steerable wheels 1a and 1b of the vehicle can be set at a wheel angle 10a, 10b relative to the longitudinal axis of the vehicle.

The apparatus contains a steering wheel 4 at which a steering wheel angle 11 can be set. A sensor arrangement 2 measures the steering wheel angle 11 and/or the wheel angles 10a, 10b. The sensor arrangement 2 is connected to a control unit 6 and transmits the measured steering wheel angles 11 and/or wheel angles 10a, 10b to the control unit 6.

An electrically actuatable steering actuator 3 can be used to set a steering angle LW in a manner independent of the driver. As a result of a steering angle LW being set by the steering actuator 3, the wheel angles 10a, 10b and preferably the steering wheel angle 11 are set. The steering actuator 3 is connected to the control unit 6. If a special control mode is active, the control unit 6 transmits steering angle requirements, which correspond to a steering angle profile LW(t), to the steering actuator 3. The steering angle requirements are implemented by the steering actuator 3 by setting the steering angle profile.

According to the example, the apparatus has a drive unit 5, for example a vehicle drive motor which is connected to one or more vehicle axles and drives the wheels of the driven axles. The drive unit 5 is connected to the control unit 6. If the special control mode is present, the control unit transmits a drive torque requirement to the drive unit 5 according to the example, which drive torque requirement is implemented by the drive unit 5 as the drive torque.

According to the example, the drive unit 5 is connected to an input interface 7 (for example a pushbutton). The driver can activate and terminate the special control mode via this input interface 7.

According to the example, the drive unit 5 is likewise connected to means 8 which reveal a brake actuation by the driver, for example a brake light switch.

According to the example, the drive unit 5 is connected to means 9 for detecting a standstill of the vehicle. A duration of the standstill is either measured by the means for detecting a standstill 9 and transmitted to the control unit 6 or is captured by the control unit 6 itself. According to the example, the special control mode is activated if a standstill is detected by the means for detecting a standstill 9 and the duration of the standstill is longer than a predefined time limit value.

In one exemplary embodiment of an aspect of the invention, an engine torque of the drive unit 5, which is transmitted to the driven axles, is captured and is transmitted to the control unit 6. According to the example, the special control mode is activated when a standstill is detected by the means for detecting a standstill 9 and the captured engine torque of the drive unit 5 is above a predefined torque limit value. The special control mode is advantageously activated only when said conditions are present during a predefined period.

In another exemplary embodiment of an aspect of the invention, the speeds of the driven wheels are captured and are transmitted to the control unit 6. According to the example, the special control mode is activated when all of the following conditions have been met:
a standstill has been determined by the means for detecting a standstill 9,
a determined drive torque of the drive unit 5 is above a predefined limit value,
all driven wheels of the vehicle have speeds greater than zero.

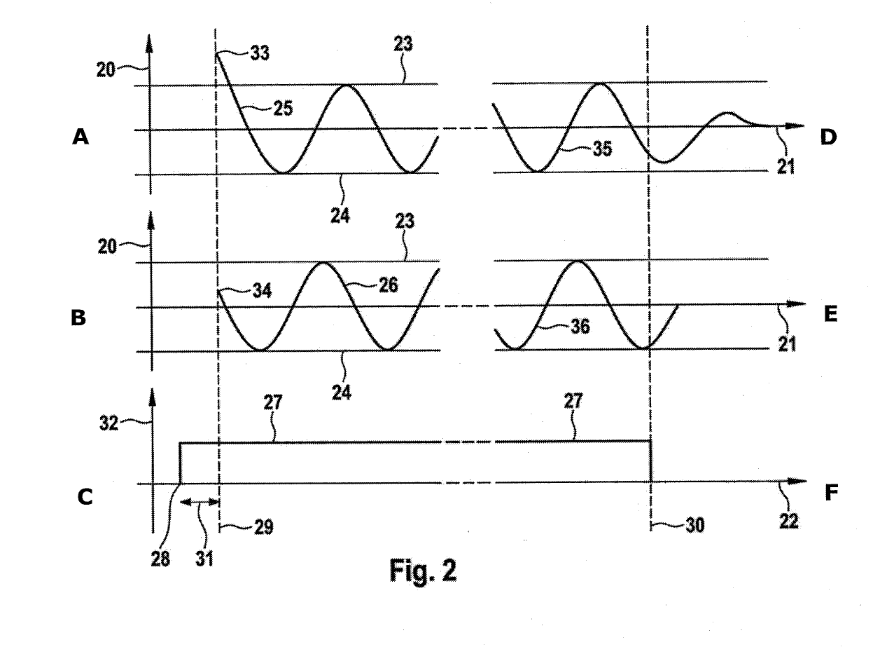

FIGS. 2A-2F show an exemplary profile of a plurality of variables while carrying out an exemplary method. In this case, the figure parts 2A, 2B, 2D and 2E show exemplary steering angle profiles 25, 26, 35 and 36 (temporal profiles LW(t)) set by a steering actuator (for example steering actuator 3 in FIG. 1) and the figure parts 2C and 2F show a status indicator 27 of a standstill detection means.

The time is respectively plotted on the x axes 21, 22, a steering angle is plotted on the y, axes 20 in the figure parts 2A, 2B, 2D and 2E and the value of the status indicator of the standstill detection means is plotted on the y axis 32 in the figure parts 2C and 2F.

FIGS. 2A, 2B and 2C each show a start of a special control mode and FIGS. 2D, 2E and 2F each show a termination of a special control mode.

At a first time 28, a standstill is detected and the status indicator 27 is set from zero (“no standstill”) to one (“standstill detected”). At the time 29, after a standstill is continuously considered to be detected for a period 31 which is longer than a predefined time limit value, a special control mode is then activated according to the example.

According to the example, a maximum steering angle value 23 and a minimum steering angle value 24 are predefined for the steering angle profile LW(t). The current steering angle at the start of the special control mode (input steering angle) 33, 34 is determined and is compared with the minimum and maximum steering angle values 23, 24.

Profile 25 in FIG. 2A shows the steering angle profile LW(t) set by the steering actuator in the special control mode in the event of the input steering angle 33 being greater than the maximum steering angle value 23. A profile accordingly reflected on the x axis is used, according to the example, if the input steering angle is less than the minimum steering angle value 24 and all subsequent considerations are similarly valid. The steering angle is first of all linearly reduced by the actuator, according to the example, until it is below the maximum steering angle value 23. In one preferred embodiment, a value for the gradient of the linear profile is predefined.

According to the example, the profile 25 then merges into a profile described by a sine function. The transition between the linear profile and the sinusoidal curve is advantageously effected in this case in such a manner that the profile can be continuously differentiated at any point since this is perceived to be particularly uniform by the driver.

Profile 26 in FIG. 2B shows the steering angle profile LW(t) set by the steering actuator in the special control mode in the event of the input steering angle being less than the maximum steering angle value 23, but greater than zero. A profile accordingly reflected on the x axis is used, according to the example, if the input steering angle 34 is less than zero but is greater than the minimum steering angle value 24. In this case, a point on the sinusoidal curve at which the sign function produces a value equal to the input steering angle is preferably determined as the starting point. The steering angle profile LW(t) now begins with the determined starting point and follows the profile 26.

As soon as the motor vehicle has propulsion again at the time 30 and a movement is carried out in the longitudinal direction, this is determined by the standstill detection means and the status indicator 27 of the standstill detection means is set to zero. According to the example, the special control mode is terminated when a standstill is no longer considered to be detected.

The special control mode is preferably not abruptly terminated, but rather the steering angle is reset by the steering actuator to a neutral position (straight-ahead position) after the end of the standstill.

In one preferred embodiment, the special control mode is terminated by linearly setting the steering angle set by the steering actuator, as shown by the steering angle profile 36 in FIG. 2E, from the value at the time 30 to zero (neutral position/straight-ahead position).

In a second preferred embodiment, the special control mode is terminated by reducing the amplitude with time, as illustrated in the profile 35 in FIG. 2D according to the example.

If the steering angle LW has been changed to the neutral position by the steering actuator, the special control mode can be terminated.

1. A method for controlling an electrically actuatable steering actuator for a motor vehicle, comprising:
checking in order to determine whether a vehicle is stuck and activating a special control mode of the steering actuator if a predefined condition is present,
setting a steering angle by the steering actuator in a manner independent of the driver and
setting a steering angle profile by the steering actuator in the special control mode.

2. The method as claimed in claim 1, wherein the steering angle profile corresponds to steering back and forth around a predefined reference value.

3. The method as claimed in claim 1, wherein the steering angle profile corresponds to a periodic profile with a predefined period and amplitude.

4. The method as claimed in claim 1, wherein a maximum steering angle and a minimum steering angle are predefined for the steering angle profile.

5. The method as claimed in claim 4, wherein the minimum steering angle and the maximum steering angle are determined according to an identified ground condition.

6. The method as claimed in claim 4, wherein the predefined minimum steering angle and the predefined maximum steering angle are temporally variable and are adapted while the special control mode is active.

7. The method as claimed in claim 1, wherein the special control mode is activated when a standstill of the motor vehicle is determined and the standstill lasts longer than a predefined time limit value.

8. The method as claimed in claim 1, wherein the special control mode is activated when a standstill of the motor vehicle is determined and a determined drive torque of the motor vehicle is above a predefined limit value.

9. The method as claimed in claim 1, wherein the special control mode is activated by an input by the driver.

10. The method as claimed in claim 1, wherein the special control mode is terminated when a movement of the vehicle in a longitudinal direction is determined.

11. The method as claimed in claim 1, wherein the special control mode is terminated by an input by the driver, wherein such an input is made,
via a pushbutton, or
by setting a brake pressure which is greater than a brake pressure limit value, or
via a movement of the steering wheel, or
by holding the steering wheel counter to the setting by the steering actuator during a predefined period.

12. The method as claimed in claim 1, wherein a drive torque is predefined by a control unit during the special control mode and the drive torque is applied to at least one driven axle.

13. The method as claimed in claim 12, wherein the drive torque is predefined by an assistance system.

14. A control unit of a motor vehicle, which comprises means for detecting when a vehicle is stuck and for controlling an electrically actuatable steering actuator of the motor vehicle, wherein a method as claimed in claim 1 is carried out by the control unit.

15. The method as claimed in claim 1, wherein the steering angle profile corresponds to steering back and forth around a neutral position.

16. The method as claimed in claim 3, wherein the periodic profile is a sine function.

17. The method as claimed in claim 12, wherein the drive torque is predefined by an automatic cruise control system.

18. The method as claimed in claim 2, wherein the steering angle profile corresponds to a periodic profile with a predefined period and amplitude.

19. The method as claimed in claim 5, wherein the predefined minimum steering angle and the predefined maximum steering angle are temporally variable and are adapted while the special control mode is active.
